(19) United States
(12) Patent Application Publication
(10) Pub. No.: US 2025/0339903 A1
(43) Pub. Date: Nov. 6, 2025

(54) HYDRAULIC EXPANSION CHUCK

(71) Applicant: Gühring KG, Albstadt (DE)

(72) Inventors: Christian STEIDLE, Albstadt (DE); Gilbert KLEINER, Inzigkofen (DE)

(73) Assignee: Gühring KG, Albstadt (DE)

(21) Appl. No.: 19/075,614

(22) Filed: Mar. 10, 2025

(30) Foreign Application Priority Data
Mar. 12, 2024 (EP) 24162960.9

(51) Int. Cl. B23B 31/30; B23B 31/107

(52) U.S. Cl. CPC B23B 31/305; B23B 31/1072; B23B 31/302

(57) ABSTRACT

What is provided is a hydraulic expansion chuck (1) with a central clamping opening extending along a longitudinal central axis (5) for receiving and clamping a tool shank and a pressure chamber, which surrounds the clamping opening and to which pressurized fluid can be applied, and which is delimited from the clamping opening by means of a radially elastically deformable dividing wall (34). A plurality of expansion joints (38), which are distributed around the clamping opening and which extend along the longitudinal central axis (5) and which are open towards the clamping opening and closed towards the pressure chamber, are formed in the dividing wall (34).

The invention relates to a hydraulic expansion chuck.

Hydraulic expansion chucks are used in a variety of ways in order to clamp a cutting tool in a clamping opening with a high concentricity.

A hydraulic expansion chuck is thus known, for example, from DE 10 2012 111 456 C5, in the case of which a pressure chamber, to which a pressurized fluid can be applied, is enclosed between the inner circumferential surface of a central receiving opening in a base body and an expansion sleeve soldered into the receiving opening. The expansion sleeve forms a relatively thin elastically deformable dividing wall in the radial direction, which delimits the pressure chamber from a clamping opening, which extends along a longitudinal central axis of the hydraulic expansion chuck and which receives a clamping shank of a cutting tool. Even though due to the base body and the expansion sleeve, which is soldered into the base body, the hydraulic expansion chuck is constructed from two components and thus in several parts, these components are permanently and firmly connected to one another by means of soldering.

WO 2017/093280 A1, in contrast, proposes a hydraulic expansion chuck, in the case of which a pressure chamber, which is delimited from a clamping opening by means of a radially elastically deformable dividing wall, is formed in a 3D-printed, i.e., generatively/additively produced clamping chuck body. The clamping chuck body is thus constructed in one piece.

In both variations, the clamping shank of a cutting tool received in the clamping opening is frictionally clamped by means of an elastic deformation of the dividing wall against the clamping shank by means of an application of the pressure chamber surrounding the clamping opening with hydraulic pressure. The torque, which can be transmitted from the hydraulic expansion chuck to the clamped-in cutting tool, is thus determined by means of the frictional connection between the dividing wall and the clamping shank. The frictional connection is attained by means of the hydraulic pressure in the pressure chamber.

The clamping opening provided in the hydraulic expansion chuck is designed for a specified clamping shank diameter. To clamp tools with a smaller clamping shank diameter than the specified clamping shank diameter, reducing sleeves, as they are known, for example, from DE 20 2011 004 231 U1 or DE 20 2015 105 500 U1, are additionally inserted into the clamping opening. Reducing sleeves of this type have longitudinal slots distributed over the circumference, which provide the reducing sleeve with the required elasticity for transmitting the clamping force from the dividing wall to the clamping shank. In contrast to the above-mentioned expansion sleeves, however, the reducing sleeves are not permanently and firmly connected to the hydraulic expansion chuck.

It has been shown, however, that it is often difficult to build up a sufficiently high frictional connection between a hydraulic expansion chuck (with or without reducing sleeve) and a tool shank, which is to be clamped. In particular in the case of a small tool shank diameter, the hydraulic pressure in the pressure chamber has to be raised significantly, depending on the application, for example for a rough machining, in order to attain the required frictional connection. On the one hand, this can have a negative impact on the service life of the dividing wall or on the sections of the hydraulic expansion chuck adjoining the dividing wall. On the other hand, pressurizations of this type have the result that the desired concentricity cannot be attained any longer over time due to the deformation of the dividing wall, which cannot be controlled any longer. The hydraulic pressure in the pressure chamber can thus not be raised without limitation, whereby the torque transmitted to the tool shank of the cutting tool is limited.

An improvement potential is generally at hand with regard to converting the hydraulic pressure built up in the pressure chamber as efficiently as possible into a radial clamping force acting on the tool shank of the cutting tool for attaining a frictional connection or a torque transmitted during operation of the hydraulic expansion chuck, respectively. In the case of relatively low hydraulic pressures in the pressure chamber, a secure frictional connection is to furthermore also be attained, whereby the service life of the dividing wall or of the sections of the hydraulic expansion chuck adjoining the dividing wall can be kept high.

The invention is thus based on the object of creating a hydraulic expansion chuck with a central clamping opening extending along a longitudinal central axis for receiving and clamping a tool shank and a pressure chamber, which surrounds the clamping opening and to which pressurized fluid can be applied, and which is delimited from the clamping opening by means of a radially elastically deformable dividing wall, by means of which the tool shank can be clamped reliably.

This object can be solved by means of a hydraulic expansion chuck with the features of claim 1. The subclaims relate to advantageous designs.

The hydraulic expansion chuck has a central clamping opening extending along a longitudinal central axis for receiving and clamping a tool shank and a pressure chamber, which surrounds the clamping opening and to which pressurized fluid can be applied, and which can be delimited from the clamping opening by means of a radially elastically deformable dividing wall. In order to solve the object, a plurality of expansion joints, which are distributed around the clamping opening and which extend along the longitudinal central axis and which are open towards the clamping opening and closed towards the pressure chamber, can be formed in the dividing wall.

The elasticity of the dividing wall is increased by means of the expansion joints, which are distributed in the dividing wall around the clamping opening and which extend along the longitudinal central axis. In response to an application of hydraulic pressure to the pressure chamber, the dividing wall can expand radially inwards, i.e., in the direction of the clamping opening or of a tool shank of a cutting tool received in the clamping opening, respectively, which is why the hydraulic pressure built up in the pressure chamber can be converted efficiently into a radial clamping force acting on the tool shank for attaining a frictional connection or a torque transmitted during operation of the hydraulic expansion chuck, respectively. The expansion joints formed in the dividing wall can furthermore reduce the tensions occurring in the dividing wall, whereby the service life of the hydraulic expansion chuck increases. The expansion joints can thereby have a wide variety of cross sectional shapes, i.e., widths and depths. The cross sectional shape is to ensure that the dividing wall has the necessary radial elasticity for securely clamping the tool shank. As a whole, the hydraulic expansion chuck is able to reliably clamp a tool shank of a cutting tool. The positive effects of the expansion joints formed in the dividing wall are attained independently of whether or not a reducing sleeve, which is known per se to the person of skill in the art, is additionally inserted in the clamping opening.

For a specified clamping opening or tool shank diameter, respectively, the expansion joints provided in the dividing wall provide for a design in such a way that the pressure chamber adjoining the dividing wall extends radially inwards up to an inner extension diameter, which is larger than when no expansion joints are formed in the dividing wall. Compared to a dividing wall having the mentioned expansion joints, the wall thickness of a dividing wall without expansion joints, measured in the radial direction, would additionally need to be significantly smaller, the dividing wall would thus need to be designed to be significantly more thin-walled, in order to be able to efficiently convert a hydraulic pressure built up in the pressure chamber adjoining the dividing wall into a radial clamping force acting on the tool shank of the cutting tool. Due to the larger inner extension diameter, a dividing wall having the expansion joint is furthermore characterized by a larger outer circumferential length and thus a larger outer circumferential surface, to which hydraulic pressure can be applied, than a dividing wall of axially equal length without expansion joints. In the case of an equally high hydraulic pressure in the pressure chamber adjoining the dividing wall, a dividing wall having the expansion joints can thus exert higher clamping forces radially inwards than a dividing wall without expansion joints.

14 to 18, in particular 16, expansion joints can be formed in the dividing wall.

Tests have shown that 14 to 18, in particular 16, expansion joints formed in the dividing wall can ensure a high stability on the one hand and a good elasticity of the dividing wall on the other hand.

In a further embodiment, the expansion joints are equidistantly distributed around the longitudinal central axis.

Due to the equidistant distribution of the expansion joints around the longitudinal central axis, the clamping force exerted on the tool shank, which is generated by means of the hydraulic pressure in the pressure chamber, acts evenly around the entire circumference of the tool shank. In other words, the radial deformation of the dividing wall can be converted into a centered constriction of the clamping opening in a uniform and in a more loss-free manner, so that the tool shank can be clamped securely and torques can be transmitted reliably.

The expansion joints can be formed as axial slots with narrow cross section.

When the expansion joints are formed as axial slots, the depth of which, measured in the radial direction of the clamping opening, is larger, in particular significantly, than the width thereof, measured in the circumferential direction of the clamping opening, the required radial elasticity of the dividing wall is attained on the one hand and the necessary stability of the dividing wall is maintained on the other hand.

In a further embodiment, the expansion joints, viewed in the direction of extension, have a U-shaped, V-shaped or rectangular cross section.

A U shape, V shape or rectangular shape can be formed in a simple way in the dividing wall. The expansion joints preferably are not formed with sharp edges, in order to avoid tension peaks in the dividing wall and to increase the service life.

In a further embodiment, the clamping opening and the expansion joints lead into a hollow space adjoining the clamping openings in the axial direction.

It is attained by means of the hollow space that the clamping opening and the expansion joints extend axially over the same length and that a clamping force can be exerted evenly to the tool shank over the full length of the clamping opening. Due to the fact that the wall material of the dividing wall separating the expansion joints from one another, i.e., so-called dividing wall webs, tapers off on the hollow space, i.e., does not abut on the base of the clamping opening, an even radial deformability of the dividing wall is attained over the full length of the clamping opening. The hollow space can in particular have a diameter, which corresponds to the diameter, up to which the expansion joints extend radially outwards, i.e., on which a base of each expansion joint lies.

The pressure chamber can extend radially inwards up to an inner extension diameter, which lies in the range of 1.6 to 1.7 times a clamping opening diameter.

The inner extension diameter is the diameter, up to which the pressure chamber extends radially inwards, i.e., towards the clamping opening, in particular in the case of pressure chamber to which no hydraulic pressure is applied. The inner extension diameter corresponds to the outer circumferential surface of the dividing wall, which delimits the pressure chamber and to which hydraulic pressure is applied when the tool is clamped. When the outer circumferential surface of the dividing wall is a circular cylindrical outer circumferential surface, the inner extension diameter is equal to the diameter of the outer circumferential surface. In the case of an outer circumferential surface, which is structured non-cylindrically, the inner extension diameter is the smallest diameter of the outer circumferential surface.

When the inner extension diameter lies in the range of 1.6 to 1.7 times the clamping opening diameter, the pressure chamber lies on a larger inner extension diameter than is the case with conventional hydraulic expansion chucks, which have the same clamping opening diameter. Compared to conventional hydraulic expansion chucks, the dividing wall thus has a larger wall thickness, it is thus thicker and more stable in the radial direction, so that higher hydraulic pressures can be applied to it for extremely high torques. A cutting tool can be clamped reliably even if extremely high torques have to be transmitted.

Due to the larger inner extension diameter, the hydraulic pressure built up in the pressure chamber additionally acts on an outer circumferential surface, which is larger with respect to the surface area, of the dividing wall delimiting the pressure chamber. Due to the larger outer circumferential surface of the dividing wall, a higher radial clamping force in the direction of the clamping opening can thus be created compared to a conventional hydraulic expansion chuck even without a pressure increase beyond the maximum hydraulic pressure specified for the conventional hydraulic expansion chuck. Due to the higher clamping force, a higher radial bending stiffness and thus a higher concentricity is attained.

The clamping opening diameter can be, for example, 20 mm and the inner extension diameter can be 33.45 mm, whereby a factor of 1.6725 results between the clamping opening diameter and the inner extension diameter.

In a further embodiment, the pressure chamber extends radially outwards up to an outer extension diameter, which lies in the range of 1.05 to 1.15 times the inner extension diameter of the pressure chamber.

Analogously to the inner extension diameter, the outer extension diameter is that diameter, up to which the pressure chamber extends radially outwards, i.e., away from the clamping opening.

In a further embodiment, the expansion joints extend radially outwards up to a diameter, which lies in the range of 1.54 to 1.58 times the clamping opening diameter.

Due to the selection of a diameter, which lies in the range of 1.54 to 1.58 times the clamping opening diameter, it can be ensured on the one hand that the depth of the expansion joints or longitudinal slots, respectively, starting at the clamping opening diameter, is not impacted and that, on the other hand, the necessary radial elasticity for securely clamping the tool shank is attained.

In a further embodiment, a maximum outer jacket diameter of the hydraulic expansion chuck can lie in the range of 2.6 to 2.9 times the clamping opening diameter in the length region of the clamping opening.

When the maximum outer jacket diameter of the hydraulic expansion chuck lies in the range of 2.6 to 2.9 times the clamping opening diameter, it can be ensured that the hydraulic expansion chuck has a high stability in the region of the clamping opening, but simultaneously has a slim design. The maximum outer jacket diameter can be, for example, 57 mm, when the clamping opening diameter is 20 mm.

The pressure chamber can form two pressure spaces, which are axially spaced apart from one another and which are connected to one another by means of a ring channel.

Due to the two pressure spaces, which are axially spaced apart from one another, it is attained that the tool shank experiences a radial clamping force at two points, which are axially spaced apart from one another, which, compared to a pressure chamber with only one pressure space, leads to a centered clamping of the tool and to a high concentricity.

In a further embodiment, at least one length section of the hydraulic expansion chuck, which has the clamping opening, dividing wall and pressure chamber, is formed in one piece.

The length section having the clamping opening, dividing wall and pressure chamber can be formed in one piece, in particular by means of a generative/additive manufacturing method, such as, e.g., a 3D printing process. A particularly high stability and strength of the length section is attained due to the one-piece formation. Compared to a multi-part construction, for example by means of an expansion sleeve, which forms the radially elastic dividing wall and which is inserted into a receiving opening of the hydraulic expansion chuck, the requirement of a sealing of the pressure chamber is eliminated. Relatively high hydraulic pressures can also be realized and high torques can be transmitted to the cutting tool in the pressure chamber with high process reliability by means of the one-piece construction. A reducing sleeve can additionally be inserted into the clamping opening in order to receive a tool shank with a smaller diameter than the clamping opening diameter.

Alternatively, the hydraulic expansion chuck can have a base body extending along the longitudinal central axis and an expansion sleeve, which is arranged in a central receiving opening in the base body and which forms the radially elastically deformable dividing wall and which is connected on its two axial ends to the base body so as to be sealed, for example in a positive manner and/or by means of a substance-to-substance bond. The hydraulic expansion chuck constructed from the base body and the expansion sleeve as well as the above-mentioned embodiment, which is formed in one piece, forms an embodiment, which can be handled in one piece, when the expansion sleeve is permanently firmly connected to the base body, for example by means of soldering. To receive a tool sank with a smaller diameter than the clamping opening diameter, a reducing bushing can additionally be inserted into the clamping opening.

The expansion sleeve can thereby sit in the receiving opening in the base body with a defined joining fit. For forming a positive connection to the base body, the expansion sleeve can in particular have a ring-shaped collar on the front side, which sits in a ring-shaped groove formed in the base body. The expansion sleeve can, for example, be soldered or welded to the base body.

The expansion sleeve can abut on the base of the receiving opening of the base body in the axial direction.

The abutment of the expansion sleeve on the base of the receiving opening provides for a particularly simple positioning. In the event that the clamping opening and the expansion joints lead into a hollow space adjoining the clamping opening, it can be prevented by means of the hollow space that material webs arranged between the expansion joints in the circumferential direction of the expansion sleeve extend axially over the entire length of the expansion sleeve and abut on the base of the receiving opening, which could lead to unwanted friction during operation of the hydraulic expansion chuck. On the shank side, the expansion sleeve can thus abut on the base of the receiving opening only in a region outside of the hollow space.

In a further embodiment, the front side of the expansion sleeve is flush with the front side of the base body.

Measured from a front side of the expansion sleeve, the expansion joints can extend over a length in the range of 0.8 to 0.9 times the length of the expansion sleeve.

Good results arise with respect to the torque transmitted by means of the expansion sleeve when the length of the expansion joints lies in the range of 0.8 to 0.9 times the length of the expansion sleeve. When the expansion sleeve abuts on the base of the receiving opening, the expansion joints can extend in particular from the front side to the shank side of the hydraulic expansion chuck and can lead into a hollow space adjoining the clamping opening.

In a further embodiment, the expansion sleeve has a structured outer jacket surface, which represents the pressure chamber.

The outer jacket surface of the expansion sleeve can in particular have different outer diameters over the axial length of the expansion sleeve. Alternatively, a structure representing the pressure chamber can be formed in the central receiving opening. In other words, the jacket surface of the expansion sleeve can, when the expansion bushing is inserted into the receiving opening of the base body, form the pressure chamber with the inner circumferential surface of the receiving opening, which pressure chamber is closed, up to a pressurized fluid supply point, which is formed, for example, by means of a branch channel leading into the pressure chamber.

The receiving opening can be formed in a circular cylindrical manner.

In terms of a simple manufacture, the receiving opening can be designed in a circular cylindrical manner. The expansion sleeve arranged in the receiving opening can accordingly have a structured outer jacket surface representing the pressure chamber.

In a further embodiment, the expansion sleeve is formed to be massive at least in the length region of the dividing wall.

Closed hollow spaces or recesses, respectively, in the region of the radially elastically deformable dividing wall can influence a radial constriction of the clamping bore when pressurized fluid is applied to the pressure chamber, so that the expansion sleeve can transmit large torques to the tool shank, which is received in the clamping opening. To form hollow spaces or recesses, respectively, of this type, however, it is required that the expansion sleeve is manufactured by means of a generative manufacturing method, for example 3D printing, whereby the manufacturing costs can increase. A massive formation of the expansion sleeve in the region of the dividing wall, can keep the manufacturing costs low. It goes without saying, however, that it would nonetheless be possible that, in addition to the expansion joints, closed hollow spaces or recesses, respectively, which can each lie between two expansion joints in the circumferential direction, are formed in the region of the radially elastically deformable dividing wall.

When the pressure chamber extends radially inwards up to an inner extension diameter, which lies in the range of 1.6 to 1.7 times the clamping opening diameter, high hydraulic pressures can be applied to the pressure chamber, as described above, so that high torques can be transmitted to the tool shank even without hollow spaces formed in the expansion sleeve, whereby the manufacturing costs can be kept low.

Further details, features and advantages follow from the following description of a preferred embodiment on the basis of the drawings, in which:

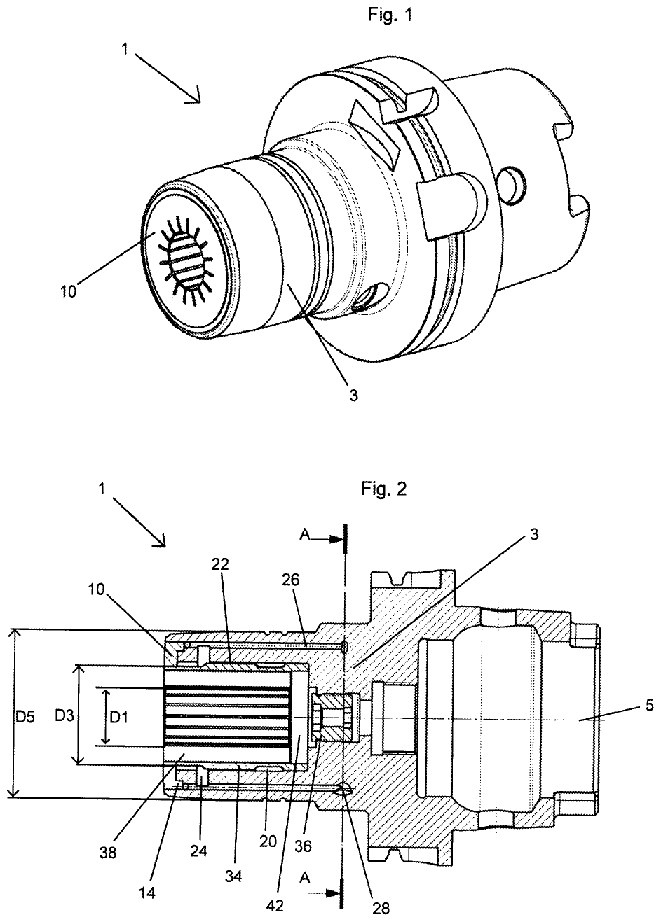

FIG. 1 shows a hydraulic expansion chuck according to one embodiment in a perspective view;

FIG. 2 shows a longitudinal sectional view of the hydraulic expansion chuck from FIG. 1;

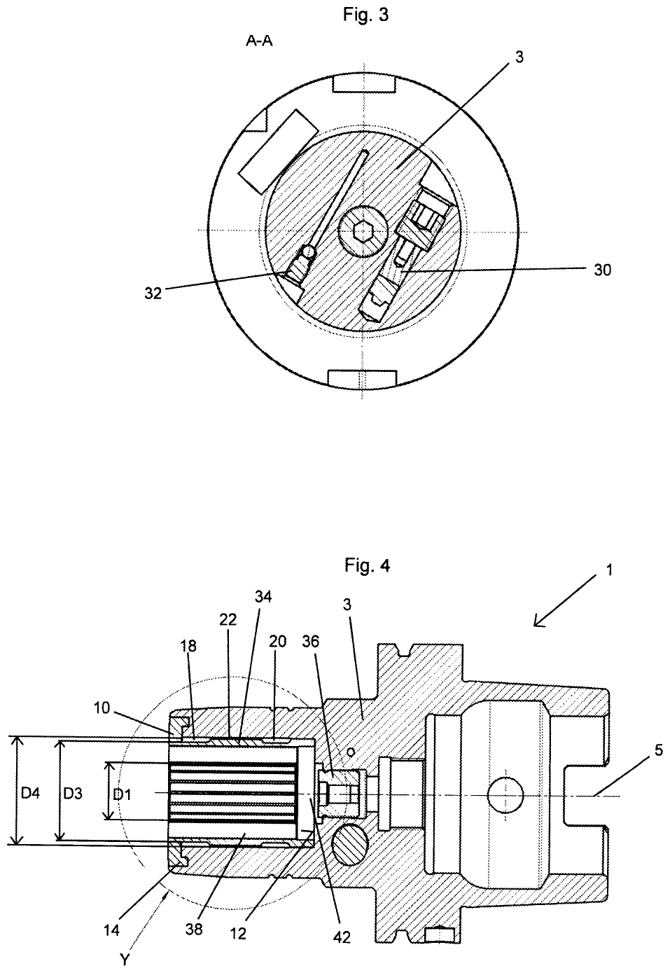

FIG. 3 shows a sectional view along the line A-A of FIG. 2;

FIG. 4 shows a further longitudinal sectional view of the hydraulic expansion chuck from FIG. 1;

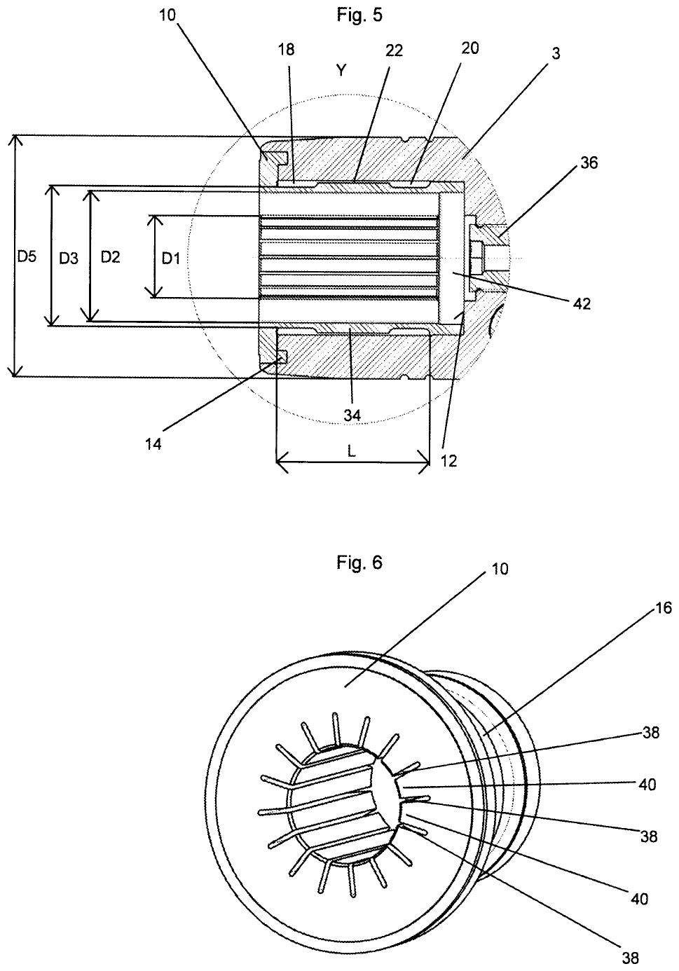

FIG. 5 shows a detailed view of the detail Y from FIG. 4; and

FIG. 6 shows a perspective view of an expansion sleeve of the hydraulic expansion chuck from FIG. 1.

A hydraulic expansion chuck is identified with reference numeral 1 in FIGS. 1 to 5, which has a base body 3 with a longitudinal central axis 5, into which an expansion sleeve 10 is inserted, which is illustrated separately in FIG. 6 in a perspective view.

In the shown embodiment, the hydraulic expansion chuck 1 with the longitudinal central axis 5 is equipped with a hollow shank taper (HSK). It is worth noting at this point that the hollow shank taper is not crucial and the hydraulic expansion chuck 1 can have a different clamping shank, for example a cylinder shank or steep taper shank, instead of the hollow shank taper.

On the front side, the base body 3 has a central circular cylindrical receiving opening, into which the expansion sleeve 10 is inserted so that a front side of the expansion sleeve 10 is flush with a front side of the base body 3 and the expansion sleeve 10 abuts on a base 12 of the receiving opening. On the one hand, the expansion sleeve 10 is connected in a positive manner to the base body 3 in that a ring-shaped collar 14 formed on the front side sits in a ring-shaped groove, which is formed accordingly in the base body 3, and, on the other hand, is connected by means of a substance-to-substance bond by soldering to the base body 3, so that a fluidic seal is formed between the expansion sleeve 10 and the main body 3. As shown in FIG. 2, the base body 3 has a maximum outer diameter D5 in the region of the central receiving opening.

In interaction with an outer jacket surface 16 of the expansion sleeve 10, an inner surface of the central receiving opening delimits a closed pressure chamber, which can be filled with pressurized fluid, of the length L, as it is shown in FIG. 5. In the shown embodiment, the structure of the outer jacket surface 16 of the expansion sleeve 10 represents the pressure chamber. The pressure chamber forms two pressure spaces, which are axially spaced apart from one another, a first pressure space 18 and a second pressure space 20, which are fluidically connected to one another by means of a circular ring channel 22. The pressure chamber is connected via a radial branch channel 24 to an axial pressurized fluid supply channel 26, via which pressurized fluid from a pressure generating chamber 28, which receives an actuating piston 30, can be fed into the pressure chamber. The channel/chamber system formed as described above can be vented via a vent screw 32 illustrated in FIG. 3.

The expansion sleeve 10 has a central clamping opening with a clamping opening diameter D1, into which a shank tool can be inserted and which can be clamped when pressurized fluid is applied to the pressure chamber. An adjusting screw 36 screwed to the base body 3 forms an axial stop for the shank tool. The pressure chamber is separated from the clamping opening by means of a radially elastically deformable dividing wall 34 of the expansion sleeve 10. In the shown embodiment, the pressure chamber extends radially inwards up to an inner extension diameter D3, which corresponds to an outer circumferential surface of the dividing wall 34, which delimits the pressure chamber. Radially outwards, the pressure chamber extends up to an outer extension diameter D4, which corresponds to the inner circumferential surface of the central receiving opening of the base body 3, into which the expansion sleeve 10 is inserted.

The radial elasticity of the dividing wall 34 is formed by 16 longitudinal slots 38, which are distributed around the clamping opening and extend along the longitudinal central axis 5 and which are open towards the clamping opening and closed towards the pressure chamber. As shown in FIGS. 2, 4 and 5, the longitudinal slots 38 extend axially from the front side over a length in the range of 0.8 to 0.9 times the length of the expansion sleeve 10. The longitudinal slots 38 extend radially outwards up to a diameter D2, which lies in the range of 1.54 to 1.58 times the clamping opening diameter D1, as shown in FIG. 6.

As is furthermore illustrated in FIG. 6, a total of 16 longitudinal slots 38, which are equidistantly arranged around the longitudinal central axis 5 and which have a U-shaped cross section, viewed in the direction of extension, are formed in the expansion sleeve 10 of the shown embodiment. Material webs 40 are formed between the longitudinal slots 38. As shown in FIGS. 2, 4 and 5, the longitudinal slots 38 and the material webs 40 lead into a hollow space 42, which is open towards the shank side of the hydraulic expansion chuck 1 and the diameter of which corresponds to the diameter D2, i.e., the base of the longitudinal slots 38. The expansion sleeve 10 therefore does not only abut in a region outside of the hollow space 42 or of the diameter D2 on the base 12 of the receiving opening, respectively.

In the shown embodiment, the pressure chamber extends radially inwards up to the inner extension diameter D3, which lies in the range of 1.6 to 1.7 times the clamping opening diameter D1. Radially outwards, the pressure chamber extends up to the outer extension diameter D4, which lies in the range of 1.05 to 1.15 times the inner extension diameter D3 of the pressure chamber.

The hydraulic expansion chuck 1 can transmit high torques with a high clamping force to the shank tool and thereby attains a higher radial bending stiffness and a higher concentricity than conventional hydraulic expansion chucks.

In the shown embodiment, the hydraulic expansion chuck is constructed in several pieces in a front-side front length region due to the expansion sleeve 1, which is inserted into the receiving opening of the base body 3. Alternatively, it is also possible, however, that the length section of the hydraulic expansion chuck having the clamping opening, dividing wall and pressure chamber is formed in one piece in particular by means of a generative/additive manufacturing method, such as, e.g., a 3D printing process.

### List of Reference Numerals

D1 clamping opening diameter
D2 diameter
D3 inner extension diameter
D4 outer extension diameter
D5 maximum outer jacket diameter
L length
1 hydraulic expansion chuck
3 base body
5 longitudinal central plane
10 expansion sleeve
12 base
14 collar
16 outer jacket surface
18 first pressure space
20 second pressure space
22 ring channel
24 branch channel
26 pressurized fluid supply channel
28 pressure generating chamber
30 actuating piston
32 venting screw
34 dividing wall
36 setting screw
38 longitudinal slot
40 material web
42 hollow space

1. A hydraulic expansion chuck with a central clamping opening extending along a longitudinal central axis for receiving and clamping a tool shank and a pressure chamber, which surrounds the clamping opening and to which pressurized fluid can be applied, and which is delimited from the clamping opening by means of a radially elastically deformable dividing wall, wherein
a plurality of expansion joints, which are distributed around the clamping opening and which extend along the longitudinal central axis and which are open towards the clamping opening and closed towards the pressure chamber, are formed in the dividing wall.

2. The hydraulic expansion chuck according to claim 1, wherein the expansion joints are equidistantly distributed around the longitudinal central axis.

3. The hydraulic expansion chuck according to claim 1, wherein the expansion joints are formed as axial slots with narrow cross section.

4. The hydraulic expansion chuck according to claim 1, wherein the expansion joints, viewed in a direction of extension, have a U-shaped, V-shaped or rectangular cross section.

5. The hydraulic expansion chuck according to claim 1, wherein the clamping opening and the expansion joints lead into a hollow space adjoining the clamping openings in an axial direction.

6. The hydraulic expansion chuck according to claim 1, wherein the pressure chamber extends radially inwards up to an inner extension diameter, which lies in a range of 1.6 to 1.7 times a diameter of the clamping opening.

7. The hydraulic expansion chuck according to claim 6, wherein the pressure chamber extends radially outwards up to an outer extension diameter, which lies in a range of 1.05 to 1.15 times the inner extension diameter of the pressure chamber.

8. The hydraulic expansion chuck according to claim 1, wherein the expansion joints extend radially outwards up to a diameter, which lies in a range of 1.54 to 1.58 times a diameter of the clamping opening.

9. The hydraulic expansion chuck according to claim 1, wherein a maximum outer jacket diameter of the hydraulic expansion chuck lies in a range of 2.6 to 2.9 times a diameter of the clamping opening in a length region of the clamping opening.

10. The hydraulic expansion chuck according to claim 1, wherein the pressure chamber forms two pressure spaces, which are axially spaced apart from one another and which are connected to one another by means of a ring channel.

11. The hydraulic expansion chuck according to claim 1, wherein at least one length section of the hydraulic expansion chuck having the clamping opening, dividing wall and pressure chamber is formed in one piece.

12. The hydraulic expansion chuck according to claim 1, characterized by a base body extending along the longitudinal central axis and an expansion sleeve, which is arranged in a central receiving opening in the base body and which forms the radially elastically deformable dividing wall and which is connected on its two axial ends to the base body so as to be sealed in a positive manner and/or by means of a substance-to-substance bond.

13. The hydraulic expansion chuck according to claim 12, wherein the expansion sleeve abuts on a base of the receiving opening of the base body in an axial direction.

14. The hydraulic expansion chuck according to claim 12, wherein a front side of the expansion sleeve is flush with a front side of the base body.

15. The hydraulic expansion chuck according to 12, wherein measured from a front side of the expansion sleeve, the expansion joints extend over a length in a range of 0.8 to 0.9 times a length of the expansion sleeve.

16. The hydraulic expansion chuck according to claim 12, wherein the expansion sleeve has a structured outer jacket surface representing the pressure chamber.

17. The hydraulic expansion chuck according to claim 12, wherein the receiving opening is formed in a circular cylindrical manner.

18. The hydraulic expansion chuck according to claim 12, wherein the expansion sleeve is formed to be massive at least in a length region of the dividing wall.
